(19) United States
(12) Patent Application Publication
(10) Pub. No.: US 2022/0129328 A1
(43) Pub. Date: Apr. 28, 2022

(54) DISTRIBUTED SYSTEM, DATA DISTRIBUTION METHOD AND PROGRAM

(71) Applicant: Nippon Telegraph and Telephone Corporation, Tokyo (JP)

(72) Inventors: Naoki HIGO, Musashino-shi, Tokyo (JP); Takuma TSUBAKI, Musashino-shi, Tokyo (JP); Yusuke URATA, Musashino-shi, Tokyo (JP); Kotaro ONO, Musashino-shi, Tokyo (JP); Kenta KAWAKAMI, Musashino-shi, Tokyo (JP); Ryota ISHIBASHI, Musashino-shi, Tokyo (JP); Takeshi KUWAHARA, Musashino-shi, Tokyo (JP)

(21) Appl. No.: 17/432,289

(22) PCT Filed: Feb. 20, 2020
(86) PCT No.: PCT/JP2020/006906

§ 371 Date: Aug. 19, 2021

(30) Foreign Application Priority Data
Feb. 21, 2019 (JP) 2019-029726

(51) Int. Cl. G06F 9/50

(52) U.S. Cl. CPC G06F 9/5083

(57) ABSTRACT

A distributed system that uses, in a network, a plurality of computational resources to perform processing on data includes an assignment unit that assigns data to a plurality of data processing units, and a determination unit that collects a data processing time in each data processing unit and a communication time between the assignment unit and each data processing unit, determines assignment of data to each data processing unit based on the data processing time and the communication time that are collected, and notifies the assignment unit of information on the determined assignment.

### TECHNICAL FIELD

The present invention relates to a system for parallelization of stream processing in consideration of communication resource usage.

### BACKGROUND ART

In a wide area network, edge computing in which computing resources having a hierarchical structure are geographically distributed is attracting attention. Also, in recent years, the examination of implementing stream processing on edge computing by using the function as a service (FaaS) is in progress. FaaS is a system architecture that utilizes a fully managed application execution environment to eliminate a unit referred to as a “server” in development and operation, and connect components on a cloud in an event-driven manner to make the maximum use of the components.

Here, there is a limit to the computing resources at each location in edge computing, and thus it is necessary to be able to flexibly utilize the resources. Further, in FaaS, in order to operate a function on EC, it is necessary to efficiently use limited computational resources and communication resources. For the efficient use of the resources, a mechanism for enabling distributed deployment of functions, job scheduling that can be dynamically controlled, and rapid scale-in/scale-out.

As the related art for the above problem, for example, there is a technology disclosed in Non Patent Literature 1. The technology disclosed in Non Patent Literature 1 is middleware that parallelizes and distributes stream processing, and is a method of performing distribution based on the processing time of a function that performs distributed processing.

In addition, Non Patent Literature 2 is a previous study on stream processing assuming a wide area network, and discloses an algorithm for determining a function of collecting analysis results analyzed at distributed locations or routing for transferring information to a function of performing the next analysis, in a wide area network environment of the limited band.

### CITATION LIST

### Non Patent Literature

Non Patent Literature 1: Apache Storm http://storm.apache.org/Non Patent Literature 2: Wenxin Li et. al., “Wide-Area Spark Streaming: Automated Routing and Batch Sizing”, IEEE Transactions on Parallel and Distributed Systems, 2018

### SUMMARY OF THE INVENTION

### Technical Problem

As disclosed in Non Patent Literature 1, in the related art, the assignment of processing when processing is distributed has been determined by the free resources of the computational resources, the processing speed, and the like of an assignment destination. However, in the related art, communication resources up to the computational resources of the distribution destination are not considered, and thus there is a problem that, when processing is distributed to the computational resources lacking the communication resources, the overall processing speed is decreased, and it is impossible to efficiently use the computational resources.

The present invention has been made in view of the above circumstances, an object of the present invention is to provide a technology of enabling appropriate assignment of data to computational resources distributed on a network.

### Means for Solving the Problem

According to a technology in the disclosure, there is provided a distributed system configured to use, in a network, a plurality of computational resources to perform processing on data, the system includes

an assignment unit configured to assign data to a plurality of data processing units, and a determination unit configured to collect a data processing time in each of the plurality of data processing units and a communication time between the assignment unit and each of the plurality of data processing units, determine assignment of data to each of the plurality of data processing units based on the data processing time and the communication time that are collected, and notify the assignment unit of information on the assignment that is determined.

### Effects of the Invention

According to the technology in the disclosure, there is provided a technology of enabling appropriate assignment of data to computational resources distributed on a network.

### BRIEF DESCRIPTION OF DRAWINGS

FIG. 1 is a diagram illustrating an example of a system configuration and a processing flow according to an embodiment of the present invention.

FIG. 2 is a diagram illustrating an example of a hardware configuration of an information processing server.

FIG. 3 is a flowchart illustrating a system operation.

FIG. 4 is a diagram illustrating a system configuration in Example 1.

FIG. 5 is a diagram illustrating a system configuration in Example 2.

### DESCRIPTION OF EMBODIMENTS

Hereinafter, an embodiment of the present invention (the present embodiment) will be described with reference to the drawings. The embodiment to be described below is merely an example, and embodiments to which the present invention is applied are not limited to the following embodiment.

### Overall Configuration of System

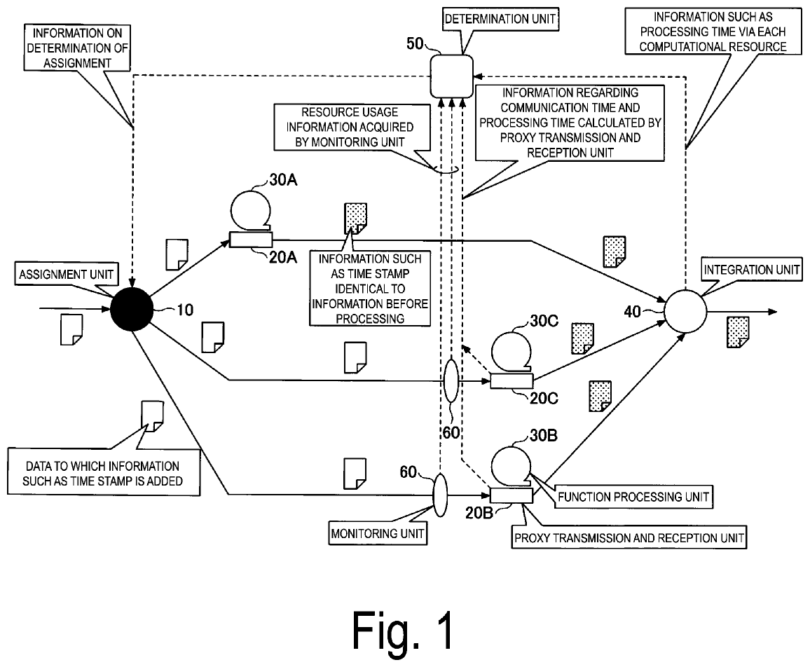

FIG. 1 is a diagram illustrating a system configuration according to the present embodiment. The system has a configuration in which a plurality of information processing servers (computers) that execute processing of data stream (example: video data stream) are provided on a network. Illustration of FIG. 1 is made focusing on a function included in the information processing server. The units illustrated in FIG. 1 may be provided in any information processing server. Each of the units illustrated in FIG. 1 may be regarded as a device (computer).

As illustrated in FIG. 1, the system includes an assignment unit 10, proxy transmission and reception units 20A to 20C, function processing units 30A to 30C, an integration unit 40, a determination unit 50, and a monitoring unit 60.

In one example of implementation, for example, a set including the proxy transmission and reception unit 20A and the function processing unit 30A, a set including the proxy transmission and reception unit 20B and the function processing unit 30B, and a set including the proxy transmission and reception unit 20C and the function processing unit 30C is each provided in one information processing server. The processing of data is performed in the information processing server in a distributed manner. One or a plurality of information processing servers may be referred to as a distributed system. The distributed system may be also be referred to as a distributed apparatus.

The monitoring unit 60 may be provided in the information processing server, or may be provided in a resource monitoring server separate from the information processing server.

When a common operation for the units A to C will be described, the proxy transmission and reception units 20A to 20C and the function processing units 30A to 30C will be described as a proxy transmission and reception unit 20 and a function processing unit 30. Data to be processed is referred to as processing target data below. Data including information on a result of computing a communication time and the like is referred to as information data below. In processing described below, “transmission” and “reception” may refer to “transmission” and “reception” inside the information processing server in addition to “transmission” and “reception” via the network. The outline of functions of the units is as follows.

The assignment unit 10 receives processing target data from a data generation source, and assigns the processing target data to the proxy transmission and reception unit 20 based on assignment information from the determination unit 50. During assignment, a time stamp is added to the processing target data.

The proxy transmission and reception unit 20 receives the processing target data from the assignment unit 10, transfers the data to the function processing unit 30. Then, the proxy transmission and reception unit 20 adds information such as a time stamp of the original processing target data to the return value from the function processing unit 30, and transmits the resultant to the integration unit 40. The proxy transmission and reception unit 20 calculates a communication time when receiving data, and obtains the return value to calculate information regarding a processing time.

The function processing unit 30 is a function of taking the processing target data as an argument and returning the value. In one example, the function processing unit 30 is a function of receiving video data as an input and performing processing such as image recognition by an AI.

The integration unit 40 calculates the communication time based on the arrival time of information data received from the proxy transmission and reception unit 20, and transmits information data including the calculated information to the determination unit 50.

The determination unit 50 determines the assignment of data to be processed, based on resource usage information, the communication time, and the processing time. Then, the determination unit 50 transmits information on the determination of the assignment to the assignment unit 10. The resource usage information may not be used in assignment determination.

The monitoring unit 60 uses SNMP/Netflow or the like to acquire the resource usage information of the network and transmits the acquired information to the determination unit 50.

### Example of Hardware Configuration

The information processing server including any one or more of the plurality of functional units illustrated in FIG. 1 can be implemented by, for example, causing a computer to execute a program describing the processing contents described in the present embodiment. The computer may be a physical machine or a virtual machine. As described above, the information processing server may include any of the functional units illustrated in FIG. 1. For example, an information processing server including only the determination unit 50 of the functional units illustrated in FIG. 1 may be provided.

The information processing server can be implemented by executing a program corresponding to processing executed by the information processing server by using hardware resources such as a CPU and a memory built in the computer. The above program can be recorded in a computer-readable recording medium (a portable memory or the like) and stored or distributed. In addition, the aforementioned program can also be provided through a network such as the Internet, an e-mail, and the like.

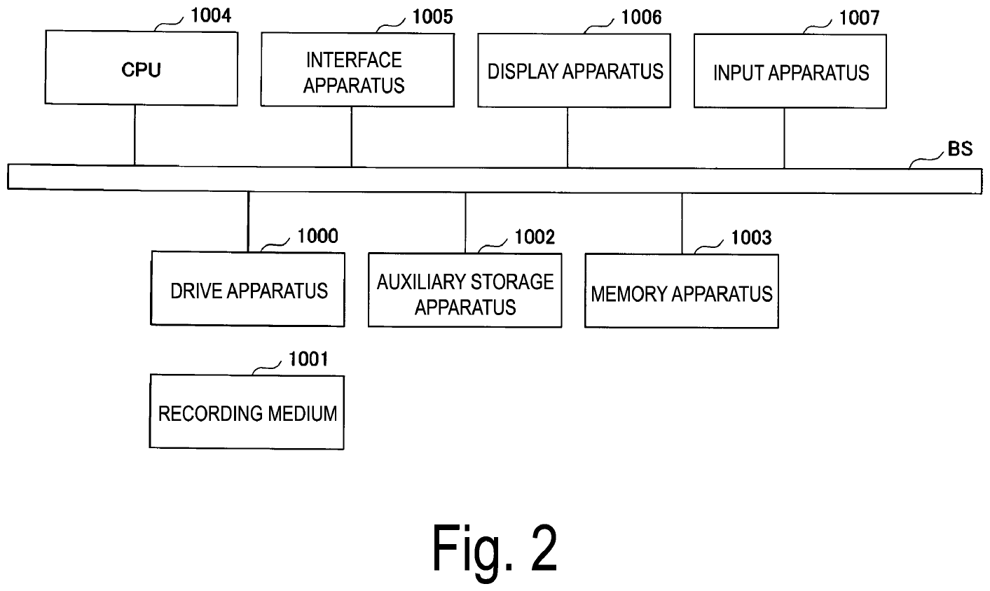

FIG. 2 is a diagram illustrating an example of a hardware configuration of the aforementioned computer in the present embodiment. The computer in FIG. 2 includes a drive apparatus 1000, an auxiliary storage apparatus 1002, a memory apparatus 1003, a CPU 1004, an interface apparatus 1005, a display apparatus 1006, an input apparatus 1007, and the like which are connected to each other through a bus B.

A program that implements processing in the computer is provided on, for example, a recording medium 1001 such as a CD-ROM or a memory card. When the recording medium 1001 storing the program is set in the drive apparatus 1000, the program is installed in the auxiliary storage apparatus 1002 from the recording medium 1001 through the drive apparatus 1000. However, the program does not necessarily have to be installed by the recording medium 1001, and may be downloaded from another computer through a network. The auxiliary storage apparatus 1002 stores the installed program and also stores necessary files, data, and the like.

The memory apparatus 1003 reads the program from the auxiliary storage apparatus 1002 and stores the program in a case where an instruction for starting the program is given. The CPU 1004 implements a function relating to the information processing server in accordance with the program stored in the memory apparatus 1003. The interface apparatus 1005 is used as an interface for connection to the network. The display apparatus 1006 displays a graphical user interface (GUI) and the like according to the program. The input apparatus 1007 includes a keyboard, a mouse, buttons, a touch panel, and the like, and is used to input various operation instructions.

### Example of Operation of System

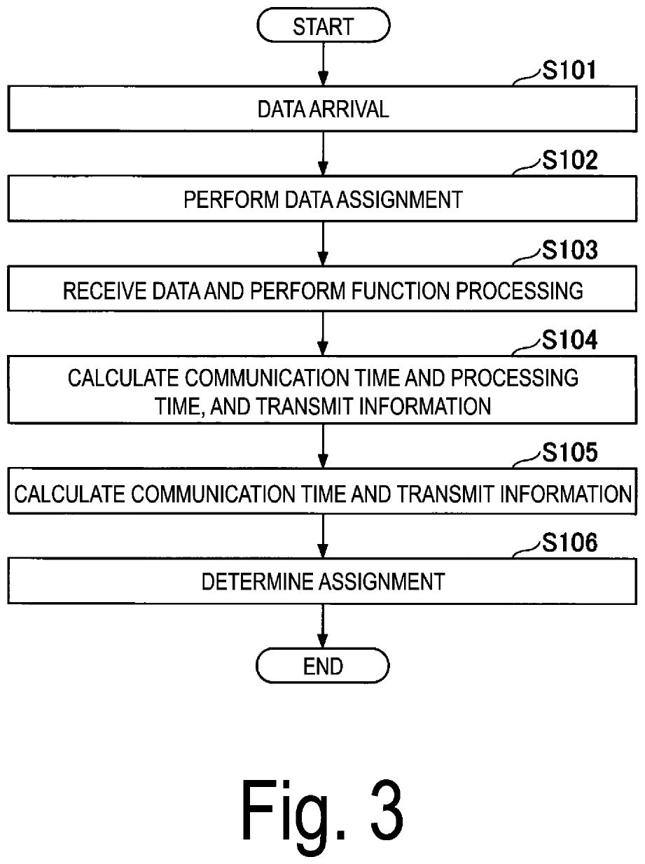

An operation example of the system illustrated in FIG. 1 will be described below in accordance with the procedure of the flowchart of FIG. 3.

In S101, processing target data arrives at the assignment unit 10. In the present embodiment, since processing of a data stream is assumed, the processing target data arrives sequentially at the assignment unit 10.

In S102, the assignment unit 10 assigns the processing target data that has arrived, to the proxy transmission and reception unit 20 based on the assignment information from the determination unit 50. A time stamp indicating a transmission time to the proxy transmission and reception unit 20 is added to the processing target data in transmission.

For example, consider performing assignment at each step of a certain time interval. When the number of allocations to the proxy transmission and reception unit 20A connected from the assignment unit 10 via a path A is S in a certain step, S pieces of data among pieces of processing target data which have arrived at this step are transmitted to the proxy transmission and reception unit 20A.

In S103, the proxy transmission and reception unit 20 receives the processing target data and transfers the processing target data to the function processing unit 30. The function processing unit 30 processes the processing target data and returns the value obtained from a result of the processing, to the proxy transmission and reception unit 20.

In S104, the proxy transmission and reception unit 20 calculates the communication time and the processing time, and transmits information data including information obtained by the calculation to the determination unit 50. In addition, the proxy transmission and reception unit 20 transmits information data including the information obtained by the calculation and a time stamp added to the original data, to the integration unit 40. The communication time and the processing time may not be transmitted from the proxy transmission and reception unit 20 to the determination unit 50. In this case, all pieces of data required for the determination are collected by the integration unit 40 and are transmitted from the integration unit 40 to the determination unit 50.

The proxy transmission and reception unit 20 calculates the communication time (outbound communication time: T_{k, i}^{out}) of a path k related to data i in Equation 1, for example. i is, for example, a sequence number added to the data.

T_{k, i}^{out}=(time of arrival at the proxy transmission and reception unit 20)−(time stamp) Equation 1

The proxy transmission and reception unit 20 calculates, for example, the processing time: T_{k, i}^{proc} of the path k related to the data i in Equation 2.

T_{k, i}^{proc}=(time when the proxy transmission and reception unit 20 receives a value from the function processing unit 30)−(time when the proxy transmission and reception unit 20 transfers processing target data i to the function processing unit 30) Equation 2

In S105, the integration unit 40 calculates the communication time based on the information data received from the proxy transmission and reception unit 20 and arrival time of the information data, and transmits information data including the calculated information to the determination unit 50.

The integration unit 40 calculates, for example, the communication time (inbound communication time: T_{k, i}ⁱⁿ) of the path k related to the data i in Equation 3.

T_{k, i}ⁱⁿ=(time of arrival at the integration unit 40)−(time stamp)−(outbound communication time)−(processing time) Equation 3

In this example, it is assumed that the assignment unit 10 and the integration unit 40 are provided in the identical information processing server. Thus, data transmission from the assignment unit 10 to the proxy transmission and reception unit 20 corresponds to the outbound path of path k. Data transmission from the proxy transmission and reception unit 20 to the integration unit 40 corresponds to the inbound path of path k.

In S106, the determination unit 50 determines the assignment based on the information data received from the proxy transmission and reception unit 20, the information data received from the integration unit 40, and the resource usage information that is received from the monitoring unit 60. A calculation example for the assignment will be described below.

Here, it is assumed that the processing target data is input to the assignment unit 10 at a time interval I, and the number of pieces of processing target data in one step is N.

The determination unit 50 determines the number of pieces of processing target data (which may be referred to as the number of jobs) for the path k in a step n+1 by calculating Tₖ^{proc}(n), Tₖ^{out}(n), Tₖⁱⁿ(n), Jₖ(n), and Cₖ(n) which will be described below. Each of the values will be described below.

Jₖ(n) indicates the number of pieces of the processing target data assigned to the path k in a step n.

Tₖ^{proc}(n) indicates the feature of the processing time measured in the step n. This is calculated, for example, by 1/NΣ_{nN≤i<(n+1)N}T_{k, i}^{proc}. This relationship represents the average of N processing times of one piece of processing target data in the path k.

Tₖ^{in/out}(n) indicates the feature of the communication time of the outbound path (out) or the inbound path (in) measured in the step n. This is calculated, for example, by 1/NΣ_{nN≤i<(n+1)N}T_{k, i}^{in/out}. This relationship represents the average of N communication times of one piece of processing target data in the path k.

Cₖ(n) indicates the feature of resources related to the path k that is measured in the step n, and refers to, for example, a communication band available on the path k.

The determination unit 50 calculates Jₖ(n+1) indicating the number of pieces of the processing target data assigned to the path k in a step n+1, by Equation 4.

Jₖ(n+1)=min(f(Tₖ^{proc}(n)), g(Tₖ^{out}(1), . . . , Tₖ^{out}(n), Tₖⁱⁿ(1), . . . , Tₖⁱⁿ(n), Cₖ(1), . . . , Cₖ(n))) Equation 4

As represented by Equation 4, Jₖ(n+1) is the smaller one of f(Tₖ^{proc}(n)) and g(Tₖ^{out}(1), . . . , Tₖ^{out}(n), Tₖⁱⁿ(1), . . . , Tₖⁱⁿ(n), Cₖ(1), . . . , Cₖ(n)).

Here, f(Tₖ^{proc}(n)) indicates the number of pieces of processing target data that are allowed to be processed in the path k in the step n+1. f(Tₖ^{proc}(n)) is calculated from the feature of the processing time in the path k in the step n, and is calculated by, for example, NI(Tₖ^{proc}(n))⁻¹. This relationship has a value obtained from dividing the time length NI of one step by the processing time (average value) of one piece of processing target data. Thus, the number of times of processing the processing target data per step is calculated.

g(Tₖ^{out}(1), . . . , Tₖ^{out}(n), Tₖⁱⁿ(1), . . . , Tₖⁱⁿ(n), Cₖ(1), . . . , Cₖ(n)) means that the number of pieces of processing target data that are communicable in the path kin the step n+1 is calculated based on information on the communication time, the communication band, and the like in the previous step. For example, an estimated value is calculated by approximating the number of pieces of communicable processing target data by linear regression.

For example, when, in the path k, the number of pieces of processing target data allowed to be processed is calculated to 100, and the number of pieces of communicable processing target data is calculated to 80, the number of pieces of processing target data assigned to the path k in the step n+1 is 80.

As described above, in S106, the number of pieces of processing target data assigned (the number of assignments) in each path is calculated, and the assignment unit 10 is notified of the information.

### EXAMPLE 1

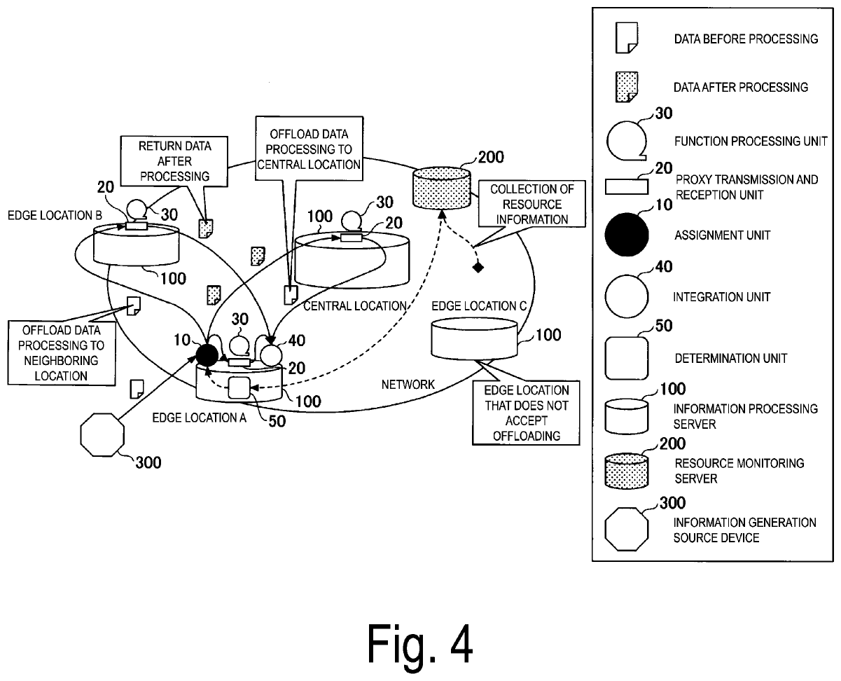

FIG. 4 illustrates Example 1. Example 1 is an example of a network of a single administrator, which is configured by a plurality of edge locations and a small number of central locations having large-scale computational resources.

As illustrated in FIG. 4, in Example 1, the information processing server 100 is provided in each of an edge location A, an edge location B, and an edge location C. Each server includes functional units as illustrated in FIG. 4.

As illustrated in FIG. 4, the information processing server 100 in the edge location A includes an assignment unit 10, an integration unit 40, and a determination unit 50. Thus, the information processing server 100 at the edge location A receives data to be processed from an information generation source device 300 and assigns the received data to the information processing server 100 at the other location. Then, the information processing server 100 at the edge location A receives processed data from the information processing server 100 at the other location and performs the above-described assignment determination. The edge location C is an edge location that does not accept offloading. Thus, it is illustrated that no offload data from other edge locations is received at the edge location C.

### EXAMPLE 2

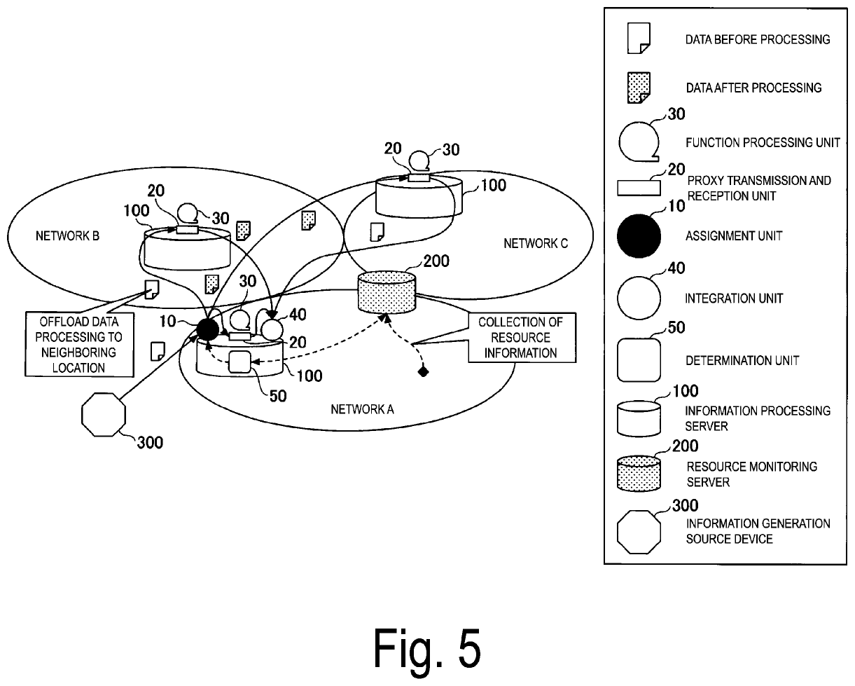

FIG. 5 illustrates Example 2. Example 2 is an example in which a plurality of networks are linked, and computational resources on each of the networks are used. In Example 2, because, in a network of another administrator, acquisition of information on communication resources may not be possible, the communication time measured by the proxy transmission and reception unit 20 is collected, and is used in assignment determination.

As illustrated in FIG. 5, in Example 2, a network A, a network B, and a network C are provided, and the information processing server 100 is provided in each of the networks A to C. Each of the servers includes functional units as illustrated in FIG. 5.

As illustrated in FIG. 5, the information processing server 100 in the network A includes an assignment unit 10, an integration unit 40, and a determination unit 50. Thus, the information processing server 100 in the network A receives data to be processed from an information generation source device 300 and assigns the received data to the information processing server 100 in the other network. Then, the information processing server 100 in the network A receives processed data from the information processing server 100 in the other network and performs the above-described assignment determination. It is impossible for the resource monitoring server 200 to collect resource information of the network B and the network C. Thus, the information processing server 100 in the network A performs the assignment determination without using the resource information of the network B and the network C.

### Effects of Embodiment

As described above, in the present embodiment, job scheduling of stream processing is performed based on the communication time and the processing time that are measured in channel based on the time stamp/sequence number added to stream data and the information on the communication resources in a wide area network of the carrier. Thus, it is possible to appropriately assign the jobs to computational resources distributed on a wide area network and to achieve efficient use of the computational resources.

### Conclusion of Embodiment

This specification describes at least the distributed system, the data assignment method, and the program of each of the following items.

### Item 1

A distributed system configured to use, in a network, a plurality of computational resources to perform processing on data, the system including

an assignment unit configured to assign data to a plurality of data processing units, and
a determination unit configured to collect a data processing time in each of the plurality of data processing units and a communication time between the assignment unit and each of the plurality of data processing units, determine assignment of data to each of the plurality of data processing units based on the data processing time and the communication time that are collected, and notify the assignment unit of information on the assignment that is determined.

A function processing unit 30 (or a proxy transmission and reception unit 20+a function processing unit 30) is an example of the data processing unit. An assignment unit 10 is an example of the assignment unit. A determination unit 50 is an example of the determination unit.

### Item 2

The distributed system according to Item 1, further including a data transmission and reception unit configured to receive data from the assignment unit and transfer the data that is received to a data processing unit of the plurality of data processing units, in which the data transmission and reception unit calculates the communication time and the data processing time.

### Item 3

The distributed system according to Item 1 or 2, further including

a monitoring unit configured to acquire resource usage information of the network,
in which the determination unit uses, in addition to the data processing time and the communication time, resource usage information that is acquired by the monitoring unit to determine the assignment.

### Item 4

The distributed system according to any one of Items 1 to 3, in which

the determination unit determines a smaller number of the number of pieces of data allowed to be processed by one data processing unit of the plurality of data processing units and the number of pieces of data allowed to be communicated with the one data processing unit, as the number of pieces of data to be assigned to the one data processing unit.

### Item 5

A data assignment method performed by a distributed system that uses, in a network, a plurality of computational resources to perform processing on data,

in which the distributed system includes an assignment unit configured to assign data to a plurality of data processing units,
the method including
collecting a data processing time in each of the plurality of data processing units and a communication time between the assignment unit and each of the plurality of data processing units, and
determining assignment of data to each of the plurality of data processing units based on the data processing time and the communication time that are collected, and notifying the assignment unit of information on the assignment that is determined.

### Item 6

A program causing a computer to operate as the determination unit in the distributed system according to any one of Items 1 to 4.

Although the present embodiment has been described above, the present invention is not limited to such a specific embodiment, and various modifications and changes can be made without departing from the gist of the present invention described in the aspects.

### REFERENCE SIGNS LIST

10 Assignment unit
20A to 20C Proxy transmission and reception unit
30A to 30C Function processing unit
40 Integration unit
50 Determination unit
60 Monitoring unit
100 Information processing server
200 Resource monitoring server
300 Information generation source device
1000 Drive apparatus
1002 Auxiliary storage apparatus
1003 Memory apparatus
1004 CPU
1005 Interface apparatus
1006 Display apparatus
1007 Input apparatus

1. A distributed system configured to use, in a network, a plurality of computational resources to perform processing on data, the distributed system comprising:
an assignment unit, including one or more processors, configured to assign data to a plurality of data processing units; and
a determination unit, including one or more processors, configured to collect a data processing time in each of the plurality of data processing units and a communication time between the assignment unit and each of the plurality of data processing units, determine assignment of data to each of the plurality of data processing units based on the data processing time and the communication time that are collected, and notify the assignment unit of information on the assignment that is determined.

2. The distributed system according to claim 1, further comprising:
a data transmission and reception unit, including one or more processors, configured to receive data from the assignment unit and transfer the data that is received to a data processing unit of the plurality of data processing units,
wherein the data transmission and reception unit is configured to calculate the communication time and the data processing time.

3. The distributed system according to claim 1, further comprising:
a monitoring unit, including one or more processors, configured to acquire resource usage information of the network,
wherein the determination unit is configured to use, in addition to the data processing time and the communication time, resource usage information that is acquired by the monitoring unit to determine the assignment.

4. The distributed system according to claim 1, wherein
the determination unit, is configured to determine a smaller number of a number of pieces of data allowed to be processed by one data processing unit of the plurality of data processing units and the number of pieces of data allowed to be communicated with the one data processing unit, as the number of pieces of data to be assigned to the one data processing unit.

5. A data assignment method performed by a distributed system that uses, in a network, a plurality of computational resources to perform processing on data,
wherein the distributed system includes an assignment unit, including one or more processors, configured to assign data to a plurality of data processing units,
the method comprising:
collecting a data processing time in each of the plurality of data processing units and a communication time between the assignment unit and each of the plurality of data processing units; and
determining assignment of data to each of the plurality of data processing units based on the data processing time and the communication time that are collected, and notifying the assignment unit of information on the assignment that is determined.

6. A non-transitory computer readable medium storing one or more instructions causing a computer to operate as a determination unit in a distributed system that uses, in a network, a plurality of computational resources to perform processing on data,
wherein the distributed system includes an assignment unit, including one or more processors, configured to assign data to a plurality of data processing units,
the one or more instructions causing the computer to execute:
collecting a data processing time in each of the plurality of data processing units and a communication time between the assignment unit and each of the plurality of data processing units; and
determining assignment of data to each of the plurality of data processing units based on the data processing time and the communication time that are collected, and notifying the assignment unit of information on the assignment that is determined.

7. The data assignment method according to claim 5, wherein the distributed system further comprises:
a data transmission and reception unit, including one or more processors, configured to receive data from the assignment unit and transfer the data that is received to a data processing unit of the plurality of data processing units,
wherein the data transmission and reception unit is configured to calculate the communication time and the data processing time.

8. The data assignment method according to claim 5,
wherein the distributed system further comprises: a monitoring unit, including one or more processors, configured to acquire resource usage information of the network,
the method further comprising:
using, in addition to the data processing time and the communication time, resource usage information that is acquired by the monitoring unit to determine the assignment.

9. The data assignment method according to claim 5, further comprising:
determining a smaller number of a number of pieces of data allowed to be processed by one data processing unit of the plurality of data processing units and the number of pieces of data allowed to be communicated with the one data processing unit, as the number of pieces of data to be assigned to the one data processing unit.

10. The non-transitory computer readable medium according to claim 6, wherein the distributed system further comprises:
a data transmission and reception unit, including one or more processors, configured to receive data from the assignment unit and transfer the data that is received to a data processing unit of the plurality of data processing units,
wherein the data transmission and reception unit is configured to calculate the communication time and the data processing time.

11. The non-transitory computer readable medium according to claim 6, wherein
the distributed system further comprises: a monitoring unit, including one or more processors, configured to acquire resource usage information of the network,
the one or more instructions further cause the computer to execute:
using, in addition to the data processing time and the communication time, resource usage information that is acquired by the monitoring unit to determine the assignment.

12. The non-transitory computer readable medium according to claim 6, wherein the one or more instructions further cause the computer to execute:
determining a smaller number of a number of pieces of data allowed to be processed by one data processing unit of the plurality of data processing units and the number of pieces of data allowed to be communicated with the one data processing unit, as the number of pieces of data to be assigned to the one data processing unit.
